(19) United States
(12) Patent Application Publication
(10) Pub. No.: US 2003/0228816 A1
(43) Pub. Date: Dec. 11, 2003

(54) Multi-layer material adapted to dissipate and reduce vibrations

(75) Inventors: Robert A. Vito, Berwyn, PA (US); Thomas Falone, Michleton, NJ (US); Carmen DiMario, West Chester, PA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Innercore Grip Company, Berwyn, PA (US)

(21) Appl. No.: 10/165,748

(22) Filed: Jun. 7, 2002

(51) Int. Cl. B32B 5/16; D03D 25/00; B32B 25/10; B32B 27/02

(52) U.S. Cl. 442/169; 442/164; 442/250; 442/260; 442/293; 442/294

(57) ABSTRACT

A multi-layer material adapted to dissipate transmitted vibrations. The material preferably has two generally independent layers including a first elastomer layer. An aramid fiber layer is disposed on the first elastomer layer. The aramid fiber layer may be woven to form a cloth layer. Additional embodiments of the mutli-layer material are disclosed herein.

### BACKGROUND

The present invention is directed to a material adapted to reduce vibration and, more specifically, to a multi-layer material adapted to dissipate and evenly distribute vibrations transmitted to one side of the material.

Handles of sporting equipment, bicycles, hand tools, etc. are often made of wood, metal or polymer that transmit vibrations that can make the items uncomfortable for prolonged gripping. Sporting equipment, such as bats, balls, shoe insoles and sidewalls, also transmit vibrations during the impact that commonly occurs during athletic contests. These vibrations can be problematic in that they can potentially distract the player's attention, adversely effect performance, and/or injure a portion of a player's body.

Rigid polymer materials are typically used to provide grips for tools and sports equipment. The use of rigid polymers allows users to maintain control of the equipment but is not very effective at reducing vibrations. While it is known that softer materials provide better vibration regulation characteristics, such materials do not have the necessary rigidity for incorporation into sporting equipment, hand tools, shoes or the like. This lack of rigidity allows unintended movement of the equipment encased by the soft material relative to a user's hand or body.

Prolonged or repetitive contact with excessive vibrations can injure a person. The desire to avoid such injury can result in reduced athletic performance and decreased efficiency when working with tools.

Clearly what is needed is a multi-layer material adapted to regulate vibration that provides the necessary rigidity for effective vibration distribution; that can dampen and reduce vibrational energy; and that preferably uses materials having Shore A durometers designed for superior vibration dissipation without compromising a person's ability to manipulate an object incorporating the material.

### SUMMARY

One embodiment of the present invention is directed to a material adapted to regulate vibration. The material includes first and second elastomer layers. A cloth layer is disposed between and generally separates the first and second elastomer layers. The cloth layer is formed of a plurality of woven aramid fibers.

In another aspect, the present invention is directed to a composite material adapted to regulate vibrations. The composite material has three generally independent and separate layers including first and second elastomer layers. A cloth layer is disposed between and generally separates the first and second elastomer layers. The cloth layer is formed of a plurality of woven aramid fibers.

In another aspect, the present invention is directed to a material adapted to regulate vibration. The material has three generally independent and distinct layers including first and second elastomer layers. A cloth layer is disposed between and generally separates the first and second elastomer layers. The cloth layer is formed of a plurality of woven aramid fibers. At least some of the plurality of woven aramid fibers are capable of moving relative to the cloth layer to allow at least some movement of the first elastomer layer relative the second elastomer layer.

In another aspect, the present invention is directed to a composite material adapted to regulate vibration. The composite material has three generally distinct layers including first and second elastomer layers. A layer formed by a plurality of aramid fibers is disposed between and generally separates the first and second elastomer layers. The first elastomer layer is capable of least some movement relative to the second elastomer layer to dissipate vibration by converting vibration to heat.

In another aspect, the present invention is directed to a material adapted to regulate vibration. The material has two independent layers including a first elastomer layer. A cloth layer is disposed on the first elastomer layer. The cloth layer is formed of a plurality of woven aramid fibers.

In another aspect, the present invention is directed to an implement having a handle at least partially enclosed in a material adapted to regulate vibration. The implement includes a handle body having a longitudinal portion and a proximal end. The material encases at least some of the longitudinal portion and the proximal end of the handle. The material has at least two generally separate and distinct layers including a first elastomer layer and a cloth layer disposed on the elastomer layer. The cloth layer is formed of woven aramid fibers.

In another aspect, the present invention is directed to a grip for an implement having a handle with a proximal handle end. The grip includes a tubular shell having a distal open end adapted to surround the portion of the handle and a closed proximal end adapted to enclose the proximal end of the handle. The tubular shell is formed of a material adapted to regulate vibration. The material has at least two generally separate layers. The material includes a first elastomer layer and a cloth layer disposed on the elastomer layer. The cloth layer is formed of woven aramid fibers.

In another aspect, the present invention is directed to a grip for an implement having a handle with a proximal handle end. The grip including a tubular shell having a distal open end adapted to surround a portion of the handle and a closed proximal end adapted to enclose the proximal end of the handle. The tubular shell is formed of a material adapted to regulate vibration. The material has at least two generally separate layers. The material includes a first elastomer layer and a layer formed by a plurality of fibers disposed on the elastomer layer.

In another aspect, the present invention is directed to a grip for an implement having a handle. The grip includes a tubular shell adapted to surround a portion of the handle. The tubular shell is formed of a material adapted to regulate vibration. The material has at least two generally separate layers. The material includes a first elastomer layer and a cloth layer disposed on the elastomer layer. The cloth layer is formed of woven aramid fibers.

### BRIEF DESCRIPTION OF THE DRAWINGS

The foregoing summary, as well as the following detailed description of the preferred embodiments of the present invention will be better understood when read in conjunction with the appended drawings. For the purpose of illustrating the invention, there are shown in the drawings embodiments which are presently preferred. It is understood, however, that the invention is not limited to the precise arrangements and instrumentality shown. In the drawings:

FIG. 1 is a cross-sectional view of a preferred embodiment of the material of the present invention; and

FIG. 2 is perspective view of the material of FIG. 1 configured to form a grip.

### DETAILED DESCRIPTION OF THE PREFERRED EMBODIMENTS

Certain terminology is used in the following description for convenience only and is not limiting. The term “implement,” as used in the specification and in the claims, means “any one of a baseball bat, racket, hockey stick, softball bat, sporting equipment, firearm, or the like.” The above terminology includes the words above specifically mentioned, derivatives thereof, and words of similar import. Additionally, the words “a” and “one” are defined as including one or more of the referenced item unless specifically stated otherwise.

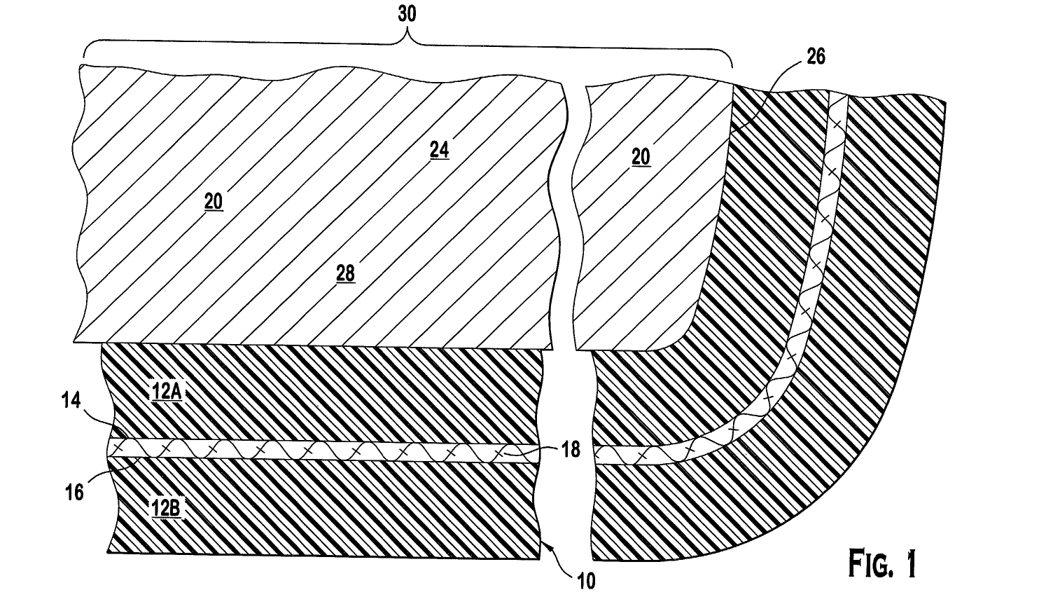

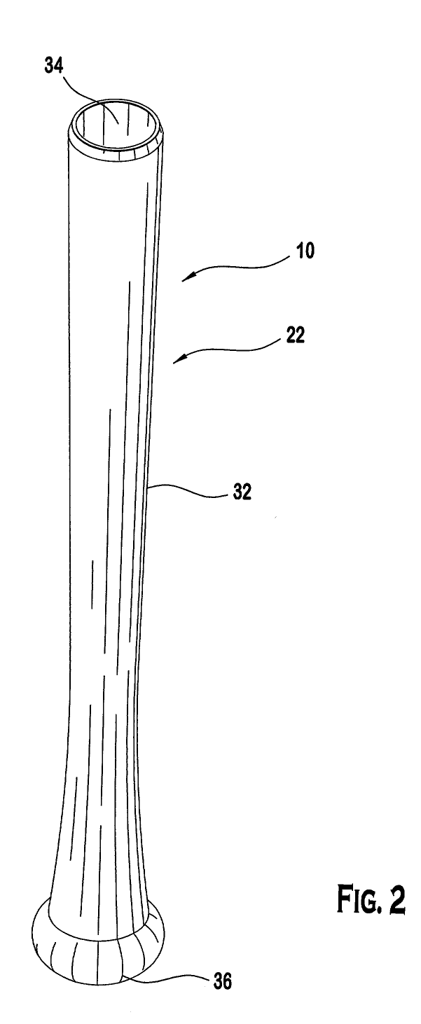

Referring to FIGS. 1 and 2, wherein like numerals indicate like elements throughout, there is shown a preferred embodiment of a material adapted to regulate vibration according to the present invention, generally designated 10. Briefly stated, the material 10 of the present invention is a multi-layer material formed by at least a first elastomer layer 12A and a layer of aramid fibers 14. The material 10 can be incorporated into athletic gear, grips for sports equipment, grips for tools, and protective athletic gear. More specifically, the material 10 can be used: to form grips for a tennis racquet, hockey sticks, golf clubs, baseball bats or the like; to form protective athletic gear for mitts, headbands, helmets, gloves, pads, or the like; to form seats or handle bar covers for bicycles, motorcycles, or the like; to form boots for skiing, roller blading or the like; to form footwear, such as shoe soles and inserts; to form grips for firearms, hand guns, rifles, shotguns, or the like; and to form grips for tools such as hammers, drills, circular saws, chisels or the like.

The first elastomer layer 12A acts a shock absorber by converting mechanical vibrational energy into heat energy. The aramid fiber layer 14 redirects vibrational energy and provides increased stiffness to the material 10 to facilitate a user's ability to control an implement 20 encased, or partially encased, by the material 10.

It is preferred that the composite material 10 have three generally independent and separate layers including the first elastomer layer 12A and a second elastomer layer 12B. Elastomer material provides vibration damping by dissipating vibrational energy. Suitable elastomer materials include, but are not limited, urethane rubbers, silicone rubbers, nitrile rubbers, butyl rubbers, acrylic rubbers, natural rubbers, styrene-butadiene rubbers, and the like. In general, any suitable elastomer material can be used to form the first and second elastomer layers without departing from the scope of the present invention.

The softness of elastomer materials can be quantified using Shore A durometer ratings. Generally speaking, the lower the durometer rating, the softer the material and the more effective an elastomer layer is at absorbing and dissipating vibration because less force is channeled through the elastomer. When a soft elastomer material is squeezed, an individual's fingers are imbedded in the elastomer which increases the surface area of contact between the user's hand and creates irregularities in the outer material surface to allow a user to firmly grasp any implement 20 covered, or partially covered, by the material. However, the softer the elastomer layers 12A, 12B, the less control a user has when manipulating an implement 20 covered by the elastomer. If the elastomer layer is too soft (i.e., if the elastomer layer has too low of a Shore A durometer rating), then the implement 20 may rotate unintentionally relative to a user's hand or foot. The material 10 of the present invention is preferably designed to use first and second elastomer layers 12A, 12B having Shore A durometer ratings that provide an optimum balance between allowing a user to precisely manipulate and control the implement 20 and effectively damping vibration during use of the implement 20.

It is preferable, but not necessary, that the elastomer used with the material 10 have a Shore A durometer of between approximately ten (10) and approximately eighty (80). It is preferred that the first elastomer layer have a Shore A durometer of between approximately ten (10) and approximately twenty-five (25) and that the second elastomer layer has a Shore A durometer of between approximately twenty-five (25) and approximately forty-five (45).

The first elastomer layer 12A is preferably used to absorb vibrational energy and to convert vibrational energy into heat energy. The second elastomer layer 12B is also used to absorb vibrational energy, but also provides a compliant and comfortable grip for a user to grasp (or provides a surface for a portion of a user's body, such as the under sole of a user's foot when the material 10 is formed as a shoe insert).

In one embodiment, the first elastomer layer 12A preferably has Shore A durometer of approximately fifteen (15) and the second elastomer layer has a Shore A durometer of approximately forty-two (42). If the first and second elastomer have generally the same Shore A durometer ratings, then it is preferable, but not necessary, that the first and second elastomer layers 12A, 12B have a Shore A durometer of fifteen (15), thirty-two (32), or forty-two (42).

The fiber layer 14 is preferably, but not necessarily, formed of aramid fibers. The fibers can be woven to form a cloth layer 16 that is disposed between and generally separates the first and second elastomer layers 12A, 12B. The cloth layer 16 can be formed of aramid fibers or other types of fiber. The cloth layer 16 preferably generally separates the first and second elastomer layers 12A, 12B causing the material 10 to have three generally distinct and separate layers 12A, 12B, 14. The aramid fiber layer 14 blocks and redirects vibrational energy that passes through one of the elastomer layers 12A or 12B to facilitate the dissipation of vibrations. The aramid fibers 18 redirect vibrational energy along the length of the fibers 18. Thus, when the plurality of aramid fibers 18 are woven to form the cloth layer 16, vibrational energy emanating from the implement 20 that is not absorbed or dissipated by the first elastomer layer 12A is redistributed evenly along the material 10 by the cloth layer 16 and then further dissipated by the second elastomer layer 12B.

It is preferable that the aramid fibers 18 be formed of a suitable polyamide fiber of high tensile strength with a high resistence to elongation. However, those of ordinary skill in the art will appreciate from this disclosure that any aramid fiber suitable to channel vibration can be used to form the aramid fiber layer 14 without departing from scope of the present invention. Additionally, those of ordinary skill in the art will appreciate from this disclosure that loose aramid fibers or chopped aramid fibers can be used to form the aramid fiber layer 14 without departing from the scope of the present invention. The aramid fibers may also be formed of fiberglass.

When the aramid fibers 18 are woven to form a cloth layer 16, it is preferable that the cloth layer 16 include at least some floating aramid fibers 18. That is, it is preferable that at least some of the plurality of aramid fibers 18 are able to move relative to the remaining aramid fibers 18 of the cloth layer 16. This movement of some of the aramid fibers 18 allows at least some movement between the first elastomer layer 12A and the second elastomer layer 12B. This movement of the first elastomer layer 12A relative to the second elastomer layer 12B converts vibrational energy to heat energy. Such motion is preferably facilitated by the first and second elastomer layers 12A, 12B only being joined at discreet locations rather than being continuously joined along a common interface. This discrete contact between the first and second elastomer layers 12A, 12B at discreet locations results in the elastomer layers 12A, 12B moving relative to one another and further dissipating vibration.

Those of ordinary skill in the art will appreciate from this disclosure that the material 10 can be formed of two independent layers without departing from the scope of the present invention. Accordingly, the material 10 can be formed of a first elastomer layer 12A and an aramid fiber layer 14 (which may be woven into a cloth layer 16) that is disposed on the first elastomer 12A.

The material 10 may be configured and adapted to form an insert for shoe. When the material 10 is configured to form a shoe insert, the material 10 is preferably adapted to extend along an inner surface of the shoe from a location proximate to a heel of the shoe to the toe of the shoe. In addition to forming a shoe insert, the material 10 can be located along the sides of a shoe to protect the wearer's foot from lateral impact.

The material 10 may be configured and adapted to form a grip 22 for an implement such as a bat, having a handle 24 and a proximal end 26 (i.e., the end proximal to where the bat is normally gripped). The material 10 is preferably adapted to enclose a portion of the handle 24 and to enclose the proximal end 26 of the bat or implement 20. As best shown in FIG. 2, it is preferable that the grip 22 be formed as a single body that completely encloses the proximal end of the implement 20. The material 10 may be also be configured and adapted to form a grip 22 for a tennis racket or similar implement 20 having a handle 24 and a proximal end 26.

While the grip 22 will be described below in connection with a baseball or softball bat, those of ordinary skill in the art will appreciate that the grip 22 can be used with any of the equipment, tools, or devices mentioned above without departing from the scope of the present invention.

When the grip 22 is used with a baseball or softball bat, the grip 22 preferably covers approximately seventeen (17) inches of the handle of the bat as well as covers the knob (i.e., the proximal end 26 of the implement 20) of the bat. The configuration of the grip 22 to extend over a significant portion of the bat length contributes to increased vibrational damping. It is preferred, but not necessary, that the grip 22 be formed as a single, contiguous, one-piece member.

The baseball bat (or implement 20) has a handle 24 including a handle body 28 having a longitudinal portion 30 and a proximal end 26. The material 10 preferably encases at least some of the longitudinal portion 30 and the proximal end 26 of the handle 24. The material 10 can be produced as a composite having two generally separate and distinct layers including a first elastomer layer 12A and an aramid fiber layer 14 (which may be a woven aramid cloth layer 16) disposed on the elastomer layer 12A. The aramid fiber layer 14 is preferably formed of woven aramid fibers 18. The second elastomer layer 12B may be disposed on a major surface of the aramid fiber layer 14 opposite from the first elastomer layer 12A.

As best shown in FIG. 2, a preferred grip 22 is adapted for use with an implement 20 having a handle and a proximal handle end. The grip 22 includes a tubular shell 32 having a distal open end 34 adapted to surround a portion of the handle and a closed proximal end 36 adapted to enclose the proximal end of the handle. The tubular shell 32 is preferably formed of the material 10 which dissipates vibration. The material 10 preferably has at least two generally separate layers including a first elastomer layer 12A and an aramid fiber layer 14 (which fibers 18 may be woven to form a cloth layer 16) disposed on the first elastomer layer 12A.

Multiple methods can be used to produce the composite or multi-layer material 10 of the present invention. One method is to extrude the material by pulling an aramid fiber cloth layer 16 from a supply roll while placing the first and second elastomer layers 12A, 12B on both sides of the woven aramid cloth layer 16. A second method of producing the material 10 of the present invention is to mold the first elastomer layer 12A onto the implement 20, then to weave an aramid fiber layer thereover, and then to mold the second elastomer layer 12B thereover. Alternatively, a cloth layer 16 can be pressured fit to an elastomer layer to form the material 10. Those of ordinary skill in the art will appreciate from this disclosure that any known method of making composite or multi-layer materials can be used to form the material 10.

The covering of the proximal end of an implement 20 by the grip 22 results in reduced vibration transmission and in improved counter balancing of the distal end of the implement 20 by moving the center of mass of the implement 20 closer to the hand of a user (i.e., closer to the proximal end 26). This facilitates the swinging of the implement 20 and can improve sports performance while reducing the fatigue associated with repetitive motion.

It is recognized by those skilled in the art, that changes may be made to the above-described embodiments of the invention without departing from the broad inventive concept thereof. For example, the material 10 may include additional layers (e.g., five or more layers) without departing from the scope of the claimed present invention. It is understood, therefore, that this invention is not limited to the particular embodiments disclosed, but is intended to cover all modifications which are within the spirit and scope of the invention as defined by the appended claims and/or shown in the attached drawings.

What is claimed is:

1. A material adapted to regulate vibration, comprising:
first and second elastomer layers; and
a cloth layer disposed between and generally separating the first and second elastomer layers, the cloth layer being formed of a plurality of woven aramid fibers.

2. The material of claim 1, wherein the first elastomer layer has a Shore A Durometer of between approximately ten (10) and approximately twenty-five (25) and the second elastomer layer has a Shore A Durometer of between approximately twenty-five (25) and approximately forty-five (45).

3. The material of claim 2, wherein the first elastomer layer has a Shore A Durometer of approximately fifteen (15) and the second elastomer layer has a Shore A Durometer of approximately forty-two (42).

4. The material of claim 1, wherein the plurality of aramid fibers comprise fiberglass.

5. The material of claim 1, wherein the cloth layer generally separates the first and second elastomer layers causing the material to have three generally distinct and separate layers.

6. The material of claim 5, wherein the first and second elastomer layers have a Shore A Durometer of approximately forty-two (42).

7. The material of claim 5, wherein the first and second elastomer layers have a Shore A Durometer of approximately fifteen (15).

8. The material of claim 5, wherein the first and second elastomer layers have a Shore A Durometer of approximately thirty-two (32).

9. The material of claim 1, wherein the material is configured and adapted to form a grip for a bat having a handle and a proximal end, the material is adapted to enclose a portion of the handle and to enclose the proximal end of the bat.

10. The material of claim 1, wherein the material is configured and adapted to form a grip for a tennis racquet having a handle and a proximal end, the material is adapted to enclose a portion of the handle and to enclose the proximal end of the tennis racquet.

11. The material of claim 1, wherein the material is configured and adapted to form a grip for an implement having a handle and a proximal end, the material is adapted to enclose a portion of the handle and to enclose the proximal end of the implement.

12. The material of claim 1, wherein the material is configured and adapted to form an insert for a shoe, the material being adapted to extend along an inner surface of the shoe from a location proximate to a heel of the shoe to a toe of the shoe.

13. The material of claim 1, wherein the cloth layer includes at least some floating aramid fibers.

14. The material of claim 1, wherein at least some of the plurality of aramid fibers can move relative to the remaining aramid fibers of the cloth layer.

15. The material of claim 1, wherein at least a portion of the first elastomer layer is moveable relative to the second elastomer layer to convert vibrational energy to heat energy.

16. A composite material adapted to regulate vibration, the composite material having three generally independent and separate layers, comprising:
first and second elastomer layers; and
a cloth layer disposed between and generally separating the first and second elastomer layers, the cloth layer being formed of a plurality of woven aramid fibers.

17. A material adapted to regulate vibration, the material having three generally independent and distinct layers, comprising:
first and second elastomer layers; and
a cloth layer disposed between and generally separating the first and second elastomer layers, the cloth layer being formed of a plurality of woven aramid fibers, at least some of the plurality of woven aramid fibers being capable of moving relative to the cloth layer to allow at least some movement of the first elastomer layer relative to the second elastomer layer.

18. A composite material adapted to regulate vibration, the composite material having three generally distinct layers, comprising:
first and second elastomer layers; and
a layer formed by a plurality of aramid fibers disposed between and generally separating the first and second elastomer layers, the first elastomer layer being capable of at least some movement relative to the second elastomer layer to dissipate vibration by converting vibration to heat.

19. A material adapted to regulate vibration, the material having two independent layers, comprising:
a first elastomer layer; and
a cloth layer disposed on the first elastomer layer, the cloth layer being formed of a plurality of woven aramid fibers.

20. An implement having a handle at least partially enclosed in a material adapted to regulate vibration, comprising:
a handle body having a longitudinal portion and a proximal end; and
the material encasing at least some of the longitudinal portion and the proximal end of the handle, the material having at least two generally separate and distinct layers including a first elastomer layer and a cloth layer disposed on the elastomer layer, the cloth layer being formed of woven aramid fibers.

21. The implement of claim 20, wherein the material includes a second elastomer layer disposed on a major surface of the cloth layer opposite from the first elastomer layer.

22. The implement of claim 20, wherein the implement is a bat.

23. The implement of claim 20, wherein the implement is a tennis racquet.

24. A grip for an implement having a handle with a proximal handle end, comprising:
a tubular shell having a distal open end adapted to surround a portion of the handle and a closed proximal end adapted to enclose the proximal end of the handle, wherein the tubular shell is formed of a material adapted to regulate vibration, the material having at least two generally separate layers, the material including a first elastomer layer and a cloth layer disposed on the elastomer layer, the cloth layer being formed of woven aramid fibers.

25. The grip of claim 24, wherein the material includes a second elastomer layer disposed on a major surface of the cloth layer opposite from the first elastomer layer.

26. The grip of claim 24, wherein the grip is a single, contiguous member.

27. A grip for an implement having a handle with a proximal handle end, comprising:
a tubular shell having a distal open end adapted to surround a portion of the handle and a closed proximal end adapted to enclose the proximal end of the handle, wherein the tubular shell is formed of a material adapted to regulate vibration, the material having at least two generally separate layers, the material including a first elastomer layer and a layer formed by a plurality of fibers disposed on the elastomer layer.

28. The grip of claim 27, wherein the material includes a second elastomer layer disposed on a major surface of the layer formed by the plurality of fibers opposite from the first elastomer layer.

29. The grip of claim 27 wherein the plurality of fibers are woven such that the layer formed by a plurality of fibers is a cloth layer.

30. The grip of claim 27, wherein the grip is a single, contiguous member.

31. A grip for an implement having a handle, comprising:
a tubular shell adapted to surround a portion of the handle, wherein the tubular shell is formed of a material adapted to regulate vibration, the material having at least two generally separate layers, the material including a first elastomer layer and a cloth layer disposed on the elastomer layer, the cloth layer being formed of woven aramid fibers.

32. The grip of claim 31, wherein the material includes a second elastomer layer disposed on a major surface of the cloth layer opposite from the first elastomer layer.

33. The grip of claim 31, wherein the grip is a single, contiguous member.
